(19) United States
(12) Patent Application Publication
(10) Pub. No.: US 2022/0212735 A1
(43) Pub. Date: Jul. 7, 2022

(54) Crawler driving device

(71) Applicants: Shengmin YAN, Jiamusi (CN); Shanshan Zhang, Jiamusi (CN); Yujie Hui, Jiamusi (CN); Xin Zhang, Jiamusi (CN)

(72) Inventors: Shengmin YAN, Jiamusi (CN); Shanshan Zhang, Jiamusi (CN); Yujie Hui, Jiamusi (CN); Xin Zhang, Jiamusi (CN)

(21) Appl. No.: 17/142,260

(22) Filed: Jan. 6, 2021

(51) Int. Cl. B62D 55/14; B62D 55/30; B62D 55/112; B62D 55/26

(52) U.S. Cl. CPC B62D 55/14; B62D 55/26; B62D 55/1125; B62D 55/30

(57) ABSTRACT

The invention is about a crawler driving device, which includes a main frame, a rotary driving wheel designs over the main frame, idler wheels design at both ends of the main frame, as well as multi-pair interval roller wheels mounted at the bottom of the main frame for fore-after driving direction, and crawlers sleeved on the outside of the drive wheels, the idler wheels and the roller sets. The driving wheel of the current invention and the tooth block inside the crawler belt are in meshing structure, so as to drive the crawler belt to rotate. The roller wheels at the bottom can swing up and down during the driving, and supporting the system as well. the roller wheels swing up and down with the rotating shaft in the middle of the mechanical balancers as the fulcrum. In case of uneven terrain, the four sets of roller wheels at the both ends of the balancer can be force-buffered at the same time, so as to ensure the stable ground drive and keeping the vehicle smoothly moving. The idler wheels guide direction, and the tensioning mechanism realizing the tension adjustment between the track and the wheel under the action of the hydro-cylinder.

### BACKGROUND OF THE INVENTION

The invention belongs to the technology field of agriculture machinery equipment, in particular to a crawler driving device.

Track is a kind of traditional driving device, with history of more than 200 years since its invention. As excellent traction ability, mobility and stability, it is still a basic form of driving device. At present, the crawler driving device is not only used in agriculture tractor, but also mainly used in rice harvester, military vehicles, construction machinery, etc.

The traditional crawler driving device has the following drawbacks: the roller set is a two-row structure, with a high pressure on each roller wheel and poor stability of the overall structure; The rubber track structure is relatively simple, single-tooth structure located in the middle of the rubber track, easy to cause uneven force on the both sides, thus causing damage to the track; the roller wheels are fixed on the track bracket, where there is an obstacle on the ground, the roller wheels bump transmit the impact force received to the machine body, thus causing the machine shake and uncomfortable to driver.

### BRIEF SUMMARY OF THE INVENTION

The invention provides a crawler driving device, to solve these problems that mentioned in the above background technology, these problems respectively are the high pressure on roller wheel, uneven pressure on rubber track, and causes the machine body's shake.

The technical problems solved by the invention are realized by the following technical solutions:

A crawler driving device, includes the main frame, the driving wheel that rotationally set over the main frame, the idler wheels that set at the both ends of the main frame, couple of roller wheels under the main frame at intervals along the driving direction of the crawler driving device, and the track that set at the outside of the driving wheel, the idler wheels and the roller wheels. wherein, the described main frame (10) includes beam (11), V-shaped brackets (12) that linked with the both sides of the beam (11) respectively, connecting rod (13) that connected the both V-shaped brackets (12), the space that is formed by V-shaped brackets (12) is used to accommodate the driving wheel (20); Described idler wheels include the guide rods that set at the both ends of the frame body, the rotating shafts that set at the end of the guide rod, and idler wheels that mounted on the both sides of the rotating shaft. Described each roller set includes the mechanical balancer, the roller wheels that rotationally connected with the both ends of mechanical balancer, The center position of the mechanical balancer rotating connected with the bottom of the main frame body. The teeth that set on the inner wall of the track engage with the driving wheel, roller wheels enable rubber track to move.

Preferably, using pin (70) to link the middle position of the both sides of the beam (11) with the bottom of V-shaped brackets (12).

Further preferably, setting restriction plates (14) in the middle position of the both sides of the beam (11) to limit the swing angle of the V-shaped brackets (12)

Preferably, the idler wheels rotationally set at the two ends of the main frame body and thus support the track, the idler wheels include the front guide idler wheel and the rear idler wheel.

Preferably, the mechanical balancer rotationally install at the bottom of the both sides of the main frame by pin.

Further preferably, The mechanical balancer includes the plate, the upper bearing seat that assembled at the bottom of the both end of the plates, the lower bearing seat which using with the upper bearing seat together and form a through-hole between the upper and the lower bearing seat, The through-hole used for inserting the rotating shaft, and the roller wheels assembled at the both sides of the rotating shaft.

Preferably, the 3 rows teeth on the inner wall of the rubber track, respectively are the first row teeth (511) the second row teeth (512) the third row teeth (513).

Further preferably, setting some teeth that used for mud cleaning at the both side of the inner wall of rubber track

Preferably, Including the tension mechanism, described tension mechanism includes the hydro-cylinder mounted on the connecting rod (13) over the upper idler wheels, and the tension idler that rotationally linked with hydro-cylinder.

The beneficial effect of the invention are:

1. The invention is mainly applied to the ground with poor operating condition, which increasing ground contact area, not only effectively prevent machine's subsidence, but also protect the field from damage.

2. The three-row teeth track structure in the invention deliver uniformly force on track and thus prolong the rubber track's life.

3. The roller wheels, idler wheels and tensioners in the invention all adopt four-row wheels structure, lowering the pressure on the each wheel and greatly improve the overall stability of the equipment.

4. The balancing structure of the roller wheels in the invention, absorbing vibration when the crawler driving device run into the obstacles, and thus ensuring the machine's smoothly driving.

5. The track in the invention is made of rubber, and has the advantages of stable moving, low noise and economic fuel consumption.

6. The double tensioning structure in the invention take advantage of even force distribution and more reliable.

### BRIEF DESCRIPTION OF THE DRAWINGS

FIG. 1 the layout drawing of the overall structure of the invention

FIG. 2 the structural layout drawing without rubber track of the invention

FIG. 3 the top view of the connection between the main frame and the roller wheels

FIG. 4 the 3D of the main frame in the invention

FIG. 5 the structural drawing of the roller wheels in the invention

FIG. 6 the structural drawing of the mechanical balancer in the invention

FIG. 7 the drawing of the inside of rubber track in the invention

FIG. 8 the structural drawing of the tensioning mechanism in the invention

Wherein, 10—the main frame 11—beam 12—V-shaped brackets 13—connecting rod
14—restriction plate 15—fixed plate 17—connecting bracket 20—driving wheel
21—rotating fluted disc 22—side plate 23—rotating disc 24—connecting bar
30—Idler wheels 301—front idler wheel 302—rear idler wheel
31—guide rod 32—the first rotating shaft 33—Idler wheel 40—Roller set
41—Mechanical balancer 411—plate 412—upper bearing seat 413—lower bearing seat
414—the third through hole 415—the fourth through hole 42—Roller wheel 50—track 51—teeth 511—the first row teeth 512—the second row teeth 513—the third row teeth 52—tooth that used for mud cleaning 60—tension mechanism 61—Hydro-cylinder 62—Idler wheel 63—supporting bracket 70—pin

### DETAILED DESCRIPTION OF THE INVENTION

In order to further explain the technical solutions of the invention, the following is a detailed elaboration of the invention through specific embodiments.

It should be noted that in the embodiments “both sides” is the left and right directions along the driving direction of the crawler driving device, “both ends” is the front and rear directions along the driving direction of the crawler driving device.

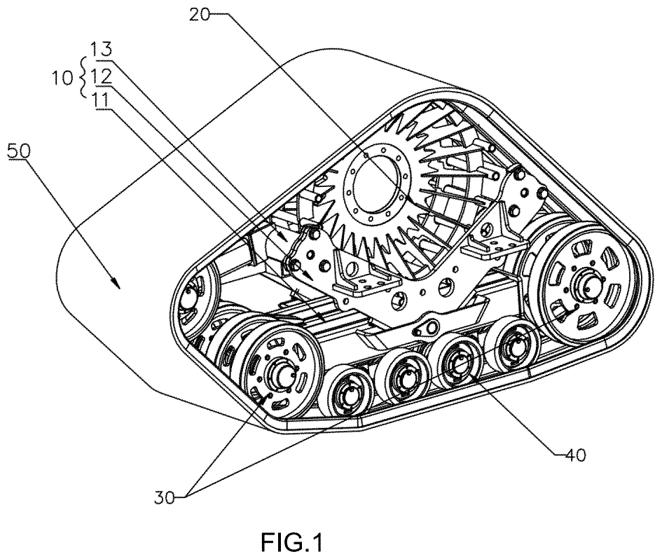

As shown in FIG. 1-8, the invention relates to a crawler driving device, includes the main frame 10, driving wheel 20, idler wheels 30, roller wheels 40, track 50 and tensioning mechanism 60

As shown in FIG. 1, the driving wheel 20 rotationally set over the main frame 10 and contact with track 50, and the driving wheel 20 is over the middle position of the main frame along the front and rear directions of the crawler driving device, the idler wheels 30 mounted on the both ends of the main frame 10, couple of roller wheels 40 installed under the both sides of frame body along the driving direction of the crawler driving device, rubber track 50 set at the outside of the driving wheel 20 idler wheels 30 roller wheels 40 and tensioning mechanism 60, the teeth on the inner wall of the rubber track 50 engage with driving wheel 20, enabling driving wheel drive rubber track to move.

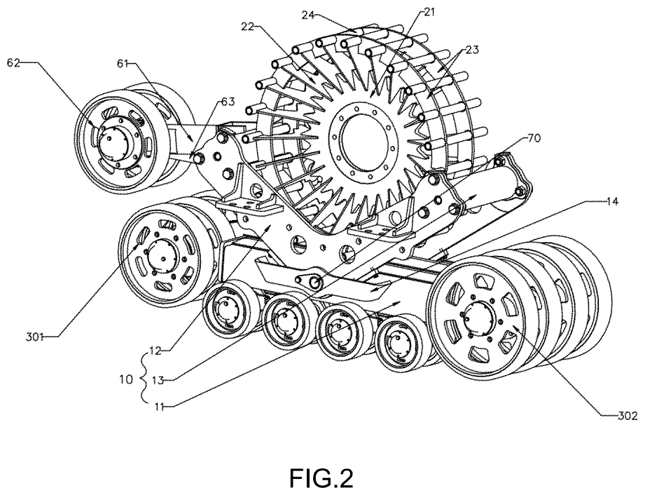

As shown in FIG. 2, Described main frame (10) includes beam (11), V-shaped brackets (12) that linked with the both sides of the beam (11) respectively, connecting rod (13) that connected the top of the one V-shaped bracket (12) with the top of the other V-shaped bracket (12); the space that is formed by V-shaped brackets (12) is used to accommodate the driving wheel (20); linking the middle position of the both sides of the beam (11) with the bottom of V-shaped brackets (12) by pin (70).

Setting restriction plate (14) in the middle position of the both sides of beam (11) in order to limit the swing angle of the V-shaped brackets (12).

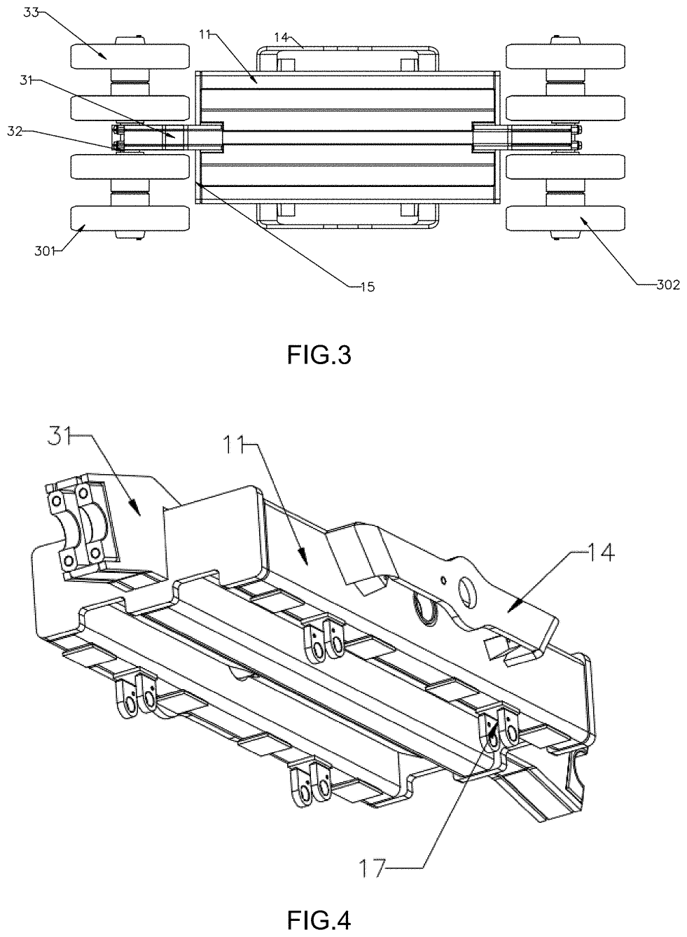

As shown in FIG. 4, the beam 11 is composed of three same supporting plates that set at intervals, the both ends of the three supporting plates respectively fixed with plate 15 into a whole, connecting bracket 17 that connect with the thrust wheel groups 40 is set at the bottom of supporting plates (As shown in FIG. 3)

As shown in FIG. 2, the driving wheel 20 includes the rotating fluted disc 21, the side plate 22, the rotating disc 23 the connection bar 24.

The side plate 22 uniformly distributed and inserted in the teeth of the rotating fluted disc 21, the rectangular notch at the bottom of the side plate 22 stuck out the center of the teeth and perpendicular to the teeth, two rotating disc 23 separately insert in the symmetrical notch at top of the side plate 22, the rotating disc 23 is perpendicular to the side plate 22 and parallel to the rotating fluted disc 21, and the center of two rotating disc is coincident, some holes uniformly set on the two rotating discs 23 and the position of holes in the two rotating disc is same, the connection bar 24 respectively inserted in the corresponding holes of the two rotating discs 23, when walking device works, the connection bar 24 drive the teeth 51 of the inner wall of track 50, thus drive track 50 to walk.

As shown in FIG. 3, the idler wheels 30 include guide rod 31 mounted on fixed plate 15, the other end of guide rod 31 rotating connect with the first rotating shaft 32, the both sides of the first rotating shaft 32 separately connect with two idler wheels 33.

The idler wheels in the invention is composed of the front idler wheel 301 and the rear idler wheel 302, separately assembled at the front and rear of the beam 11.

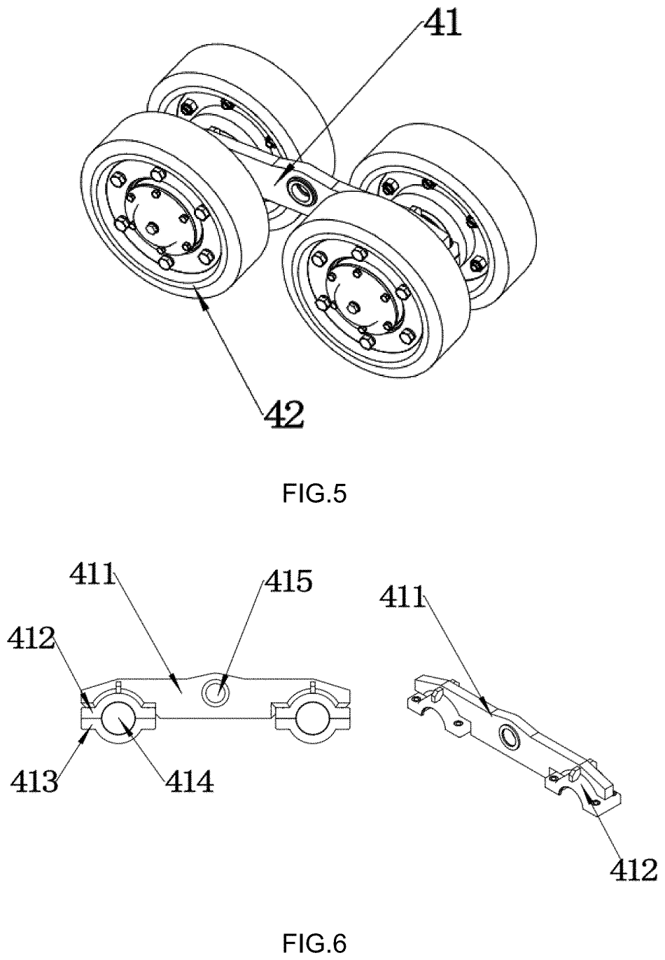

As shown in FIG. 2 FIG. 5 FIG. 6, there are 4 roller wheel sets, separately rotationally assembled at the bottom of the both sides of the main frame by pin 70, each roller wheel 40 includes mechanical balancer 41, the roller wheel 42 rotating connect with the both ends of the mechanical balancer 41.

As shown in FIG. 6, The mechanical balancer 41 includes the plate 411, the upper bearing seat 412 that assembled at the bottom of the both ends of the plates 411, the lower bearing seat 413 that using with upper bearing seat together and form a through-hole 414 between the upper bearing seat and the lower bearing seat, the through-hole 414 used for inserting the second rotating shaft (not show in picture), and the roller wheels 42 assembled at the both sides of the second rotating shaft, and the roller wheels 42 is at the both sides of the plates 411.

Setting the fourth through hole 415 at the top of the middle of the plate 411, which link with the connecting bracket 17 by pin 70.

There are 4 roller wheels 42 for each roller set in the invention.

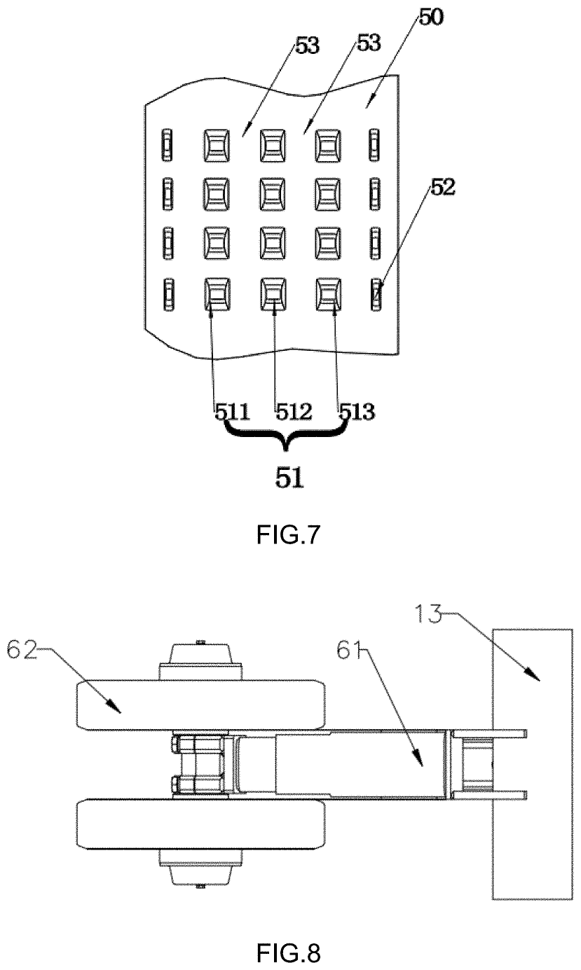

As shown in FIG. 7, the teeth 51 uniformly distributed on the inner wall of the track 50, Set 3 rows teeth (51) on the inner wall of the rubber track (50), respectively are the first row teeth (511) the second row teeth (512) the third row teeth (513); the driving device works, the teeth 51 engage with the driving wheel 20, the driving wheel 20 drive the 3 rows teeth 51 and then the track 50 to rotate, the design of 3 rows teeth 51 make more even force on the track, and effectively improve the force distribution on track 50, and prolong the rubber track 50 life.

There are same interval space 53 during 3 rows teeth, the interval space 53 can accommodate the two middle wheels of the idler wheels 30 the roller wheels 40 and the tensioners 60

Setting some teeth 52 at the two ends of the inner wall of the rubber track 50, and distributed at same interval, the shape of tooth 52 is similar to pyramid make the mud to easily drop from the track 50 and thus achieve the effect of cleaning.

As shown in FIG. 2 FIG. 8, the tension mechanism 60 includes hydro-cylinder 61, tension wheel group 62, the one end of the hydro-cylinder 61 fixed on the connection rod 13 by supporting bracket 63, the other end link with tensioned 62 by pin.

The Implement Process of the Invention

The V-shaped bracket 12, driving wheel 20 is installed on driving axle of the machine, when the driving axle turn, the driving wheel move as well, driving wheel 20 engage with the teeth of inner wall of the rubber track, thereby drive track 50 to move, the roller set swing up and down during moving, and also supporting frame for the crawler driving device. The roller wheel at the both sides of the main frame can swing up and down with taking the rotating shaft 416 in the middle of the oscillating deck as fulcrum. when the crawler driving device run into obstacles, the four roller wheel sets at the both ends of the mechanical balancer buffers force synchronously, thus ensure smoothly drive. the idler wheels mainly play guiding role, the tension mechanism achieves tensioning adjustment between track and wheel groups under the action of the hydro-cylinder.

The above embodiments of the invention are described in detail, but the contents are only the better embodiments of the invention and should not be considered as limiting the scope of implementation of the invention, any equal changes and improvement made in accordance with the scope of the invention remain within the scope of the invention patent.

What is claimed is:

1. A crawler driving device, includes the main frame (10), the driving wheel (20) that rotationally set over the main frame (10), the guide wheel groups (30) that rotationally set at the both ends of the main frame (10), couple of roller wheels (40) that fix under the main frame (10) at intervals along the driving direction of the crawler driving device, and the track (50) that set at the outside of driving wheel (20), idler wheels (30) and roller wheel (40), features are,
The described main frame (10) includes beam (11), V-shaped brackets (12) that linked with the both sides of the beam (11) respectively, connecting rod (13) that connected the both V-shaped brackets (12); the space that is formed by V-shaped brackets (12) is used to accommodate the driving wheel (20);
The described idler wheels (30) include the guide rods (31) that set at the both ends of the beam (11), the rotating shaft (32) that set at the end of the described guide rod (31), and idler wheel (33) that set at the both sides of the rotating shaft (32).
The described each roller set (40) includes the mechanical balancer (41), roller wheels (42) that rotationally connected with the both ends of the mechanical balancer (41), the center position of the mechanical balancer (41) rotating connected with the bottom of the beam (11).
The teeth (51) that set on the inner wall of the track (50) engage with driving wheel (20), roller wheels (20) enabling rubber track (50) to move.

2. According to claim 1, the characteristic of the crawler driving device lie in using pin (70) to link the middle position of the both sides of the beam (11) with the bottom of V-shaped brackets (12)

3. According to claim 2, the characteristic of the crawler driving device lie in: setting restriction plates (14) in the middle position of the both sides of beam (11) to limit the swing angle of the V-shaped brackets (12).

4. According to claim 2, the characteristic of the crawler driving device lie in, the idler wheels (30) rotationally set at the both ends of the beam (11) and support the rubber track (50), the idler wheels (30) include the front idler wheel (301) and the rear idler wheel (302).

5. According to claim 1, the characteristic of the crawler driving device lie in, the mechanical balancer (41) rotationally install under the both ends of the beam (11) by pin (70).

6. According to claim 5, the characteristic of the crawler driving device lie in, the mechanical balancer (41) includes the plate (411), the upper bearing seat (412) that assembled at the bottom of the both ends of the plate (411), the lower bearing seat (413) that using with upper bearing seat (411) together and form a through-hole (414) between upper bearing seat (412) and lower bearing seat (413), The through-hole (414) used for inserting a rotating shaft (415), and the roller wheels (42) assembled at the two sides of the rotating shaft (415)

7. According to claim 1, the characteristic of crawler driving device lie in, setting 3-row teeth (51) on the inner wall of the rubber track (50), respectively are the first row teeth (511) the second row teeth (512) the third row teeth (513).

8. According to claim 7, the characteristic of the crawler driving device lie in, set some teeth that used for mud cleaning (52) at the both sides of the inner wall of the rubber track (50)

9. According to claim 1, the characteristic of the crawler driving device lie in, includes the tension mechanism (60), and the tension mechanism (60) includes hydro-cylinder (61) mounted on the connecting rod (13) over the front idler wheel (301), and the tensioned set (62) that rotationally linked with hydro-cylinder (61).
